(19) United States
(12) Patent Application Publication
(10) Pub. No.: US 2014/0330867 A1
(43) Pub. Date: Nov. 6, 2014

(54) SOFTWARE DESIGN PATTERN FOR ADAPTING A GRAPH DATABASE VISUALIZATION SOFTWARE

(71) Applicant: Silicon Graphics International Corp., Milpitas, CA (US)

(72) Inventors: Sanhita Sarkar, Fremont, CA (US); Raymon Morcos, Sunnyvale, CA (US)

(73) Assignee: Silicon Graphics International Corp., Milpitas, CA (US)

(21) Appl. No.: 14/266,656

(22) Filed: Apr. 30, 2014

Related U.S. Application Data
(60) Provisional application No. 61/818,282, filed on May 1, 2013.
(60) Provisional application No. 61/841,279, filed on Jun. 29, 2013.

(51) Int. Cl. G06F 17/30

(52) U.S. Cl. CPC G06F 17/30277
USPC 707/772

(57) ABSTRACT

An adapter retrieves graph data from one or more graph databases and adapts the data to be shown through a visualization tool. The adapter may be used to convert multiple formats of graph data into a format which is readable and useable by the visualization tool. The adapter module may make a connection with a graph database and query the database for particular graph data. Once retrieved, the stream of retrieved graph data may be used to populate a template in Java form. From the template, the visualization tool may provide a visualization of the retrieved data.

### CROSS REFERENCE TO RELATED APPLICATIONS

This application claims the priority benefit of U.S. provisional application 61/818,282, titled “Flexible, Scalable, and Integrated Big Data Ecosystem for Data Ingestion, Analytics, and Visualization,” filed May 1, 2013, and the priority benefit of U.S. provisional application 61/841,279, titled “Software Design Pattern for Adapting A Graph Database Visualization Software,” filed Jun. 29, 2013, the disclosures of which are incorporated herein by reference.

### BACKGROUND

Big data has become a large business for many companies looking to analyze large amounts of data. Typically, data to be visualized is stored in a graph database and viewed using a visualization tool. Most graph database vendors provide a specific format for their data. As such, a visualization tool is usually only compatible with a single type of graph database.

For example, a graph database which provides information regarding nodes and relationships may only be viewable through a particular visualization tool. A provider for visualization tool software often collaborates with a single graph database provider to make their products compatible. This narrow collaboration makes it difficult to access data from multiple sources and view them simultaneously. What is needed is a way to view multiple types of graph data in a single visualization tool.

### SUMMARY

A software design pattern is provided for adapting a JavaScript toolkit for visualizing networks for use in major browsers and using HTML 5. The software design pattern may work with graph database visualization software for any graph database. No single visualization vendor is compatible with all vendors. A technique presented here uses a SGI design pattern for visualization and allows a system visualization software to be used against any graph database. The present design pattern is separated into three stages. In stage 1, called layout, a graph database is loaded after which standard relationships and nodes can be formatted. In stage 2, called connect, the java client can be written to extract the format defined in stage 1. In stage 3, called visualization-hook, JavaScript tools are used to hook the client output to the visualization layer.

A method for method for visualizing data may retrieve data from a database in a first format. The retrieved data may be adapted to a second format compatible with a visualization interface. A visualization may be provided based on the retrieved data having the second format.

A system for visualizing data may include a processor, memory, and one or more modules stored in memory. The one or more modules may be executable by the processor to retrieve data from a database in a first format, adapt the retrieved data to a second format compatible with a visualization interface, and provide a visualization based on the retrieved data having the second format.

### BRIEF DESCRIPTION OF THE DRAWINGS

FIG. 1 is a block diagram of a system for adapting graph data.

FIG. 2 is a graphical interface provided by a visualization tool.

FIG. 3 is a block diagram for providing a visualization capability by a visualization tool based on retrieved data.

FIG. 4 is a method for retrieving data from a graph database.

FIG. 5 is a method for providing a visualization capability

FIG. 6 is a block diagram of an exemplary computing device for implementing the present technology.

### DETAILED DESCRIPTION

The present system includes an adapter configured to retrieve graph data from one or more graph databases and adapt the data to be shown through a visualization tool. The adapter may be used to convert multiple formats of graph data into a format which is readable and useable by the visualization tool. The adapter module may make a connection with a graph database and query the database for particular graph data. Once retrieved, the stream of retrieved graph data may be used to populate a template in Java form. From the template, the visualization tool may provide a visualization of the retrieved data.

A software design pattern is provided for adapting a JavaScript toolkit for visualizing networks for use in major browsers and using HTML 5. The software design pattern may work with graph database visualization software for any graph database.

Graph database visualization software is too specific to display in a web application for different database vendors. Each graph database vendor has a design for their data structure. No single visualization vendor is compatible with all vendors. A technique presented here uses a SGI design pattern for visualization and allows a system visualization software to be used against any graph database. The present design pattern is separated into three stages. In stage 1, called layout, a graph database is loaded after which standard relationships and nodes can be formatted. In stage 2, called connect, the java client can be written to extract the format defined in stage 1. In stage 3, called visualization-hook, JavaScript tools are used to hook the client output to the visualization layer.

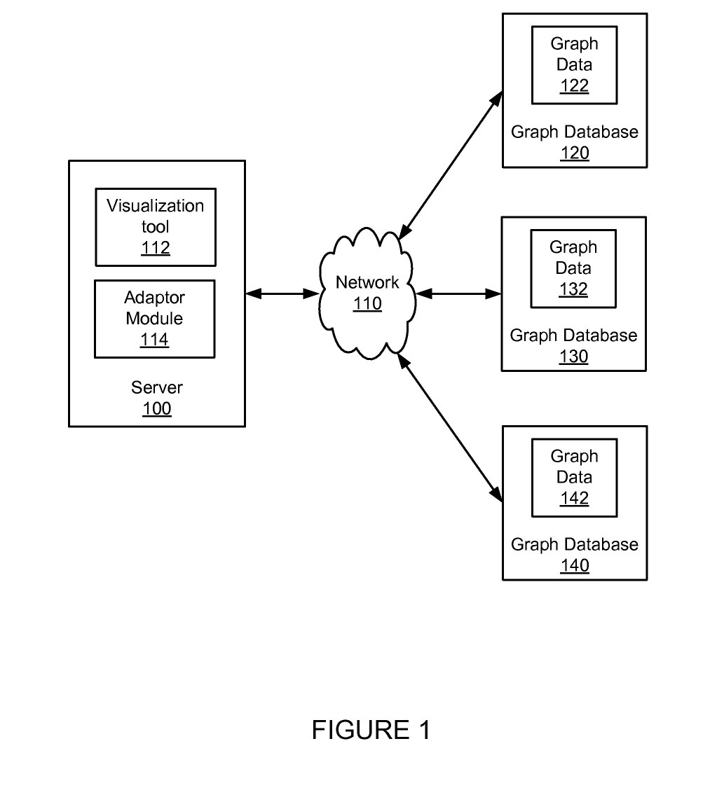

FIG. 1 is a block diagram of a system for adapting graph data. The system of FIG. 1 includes server 100, network 110, and graph databases 120, 130 and 140. Server 100 may include visualization tool 112. The visualization tool may be used to provide graphical representations of graph data through a graphical interface.

Server 100 also includes adapter module 114. Adapter module 114 may develop a connection with one or more graph databases 120-140, and query each database for data. The data may be a particular type of data which may be graphically visualized through visualization tool 112. More functionality of adapter module 114 is discussed below. Though depicted as located on server 100, adaptor module may be placed outside of server 100 and may receive a data stream from graph databases 120-140. In some embodiments, the graph database and data, visualization tool and adaptor module may be implemented on the same machine, in which case the adaptor module may process data provided from a graph database to visualization tool 112.

Server 100 may communicate with the databases 120-140 through network 110. Network 110 may include a public network, a private network, a local area network, a wide area network, a wireless network, a cellular network, an intranet, the Internet, a combination of these networks or any other communication layer.

Graph database 120 may include a database of data in graph format. The data may include and describe relationships between objects as well as their attributes. The graph data 122 may be accessed by applications, tools and machines external to the database, such as for example visualization tool 112 and adaptor module 114. Similar to graph database 120, graph database 130 and 140 include graph data 132 and 142, respectively. Graph databases 130-140 may also be queried for their graphical data by an external module such as for example visualization tool 112 and adaptor module 114.

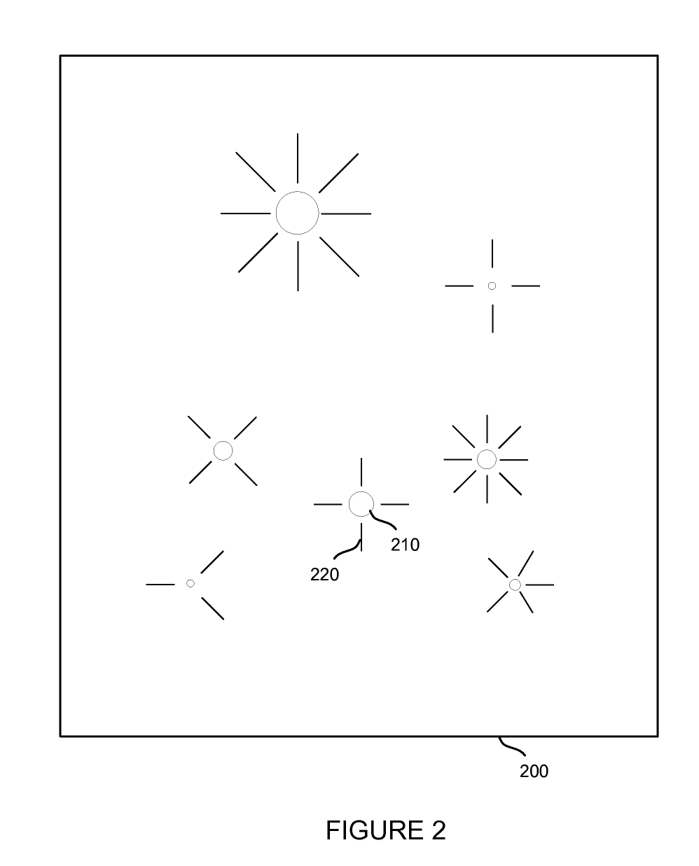

FIG. 2 is a graphical interface provided by a visualization tool. The visualization may be provided by visualization tool 112. As shown, the interface of FIG. 2 includes multiple nodes with information regarding one or more relationships associated with each node. For example, node 130 includes four relationships 132 extending from the node. The different sizes of the nodes in graphical interface 200 represents different information associated with each node, such as for example the number of data points within each node, a value for each node, or other information. The number of lines extending from the nodes may represent information such as a particular relationship associated with that node. The data associated with the nodes such as node 210 and the relationships 220 may be retrieved from one or more graph databases 120-140 as graph data and adapted to visualization tool 112 by adapter module 114.

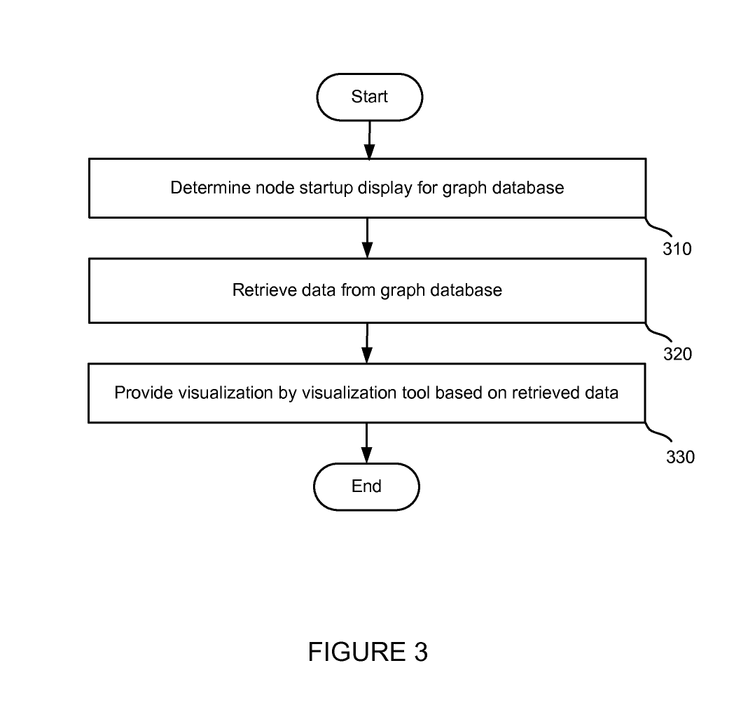

FIG. 3 is a block diagram for providing a visualization capability by a visualization tool based on retrieved data. First, a node start up display is determined for a graph database at step 310. A user may install and load the graph database software. The top node layer may be defined as the first node(s) that need to be displayed as soon as the graph is launched. If the graph has disconnected regions, the top nodes of the disconnected regions may be displayed. A query may be created using the database query language. In embodiments, all top display nodes may be returned in this query. A standard software programming model, such as for example a Keylines software programming model, may be used to display the top nodes.

Next, data is retrieved from the graph database at step 320. Retrieving data may include establishing a connection with a graph database, querying the graph database for the data, and then receiving and processing the stream of data received from the graph database by the adapter module.

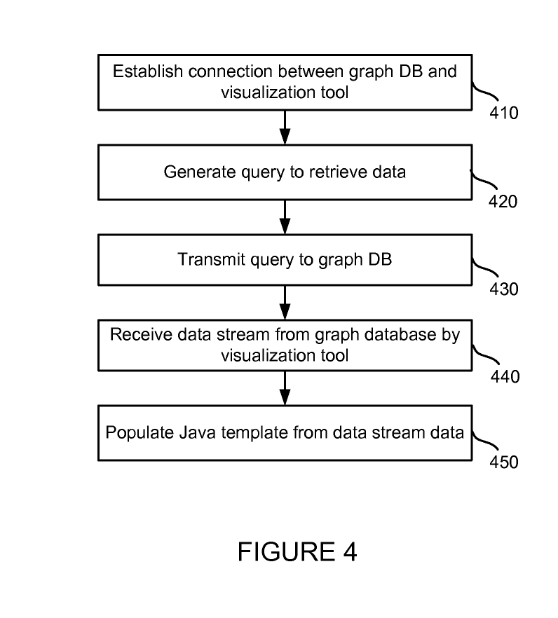

To retrieve the data, a connect layer program may be implemented from the graph database to a visualization software at step 120. In embodiments, the query used within a J2EE program may be formatted to output a JSON conversion. For each node selection, the query and JSON conversion may be different. This can be done with one or more J2EE programs. The JSON conversion output must contain both the relationship and node value. It may contain properties if display is desired by a user. The connect layer will allow any graph database technology to connect to software such as Keylines visualization software. Retrieving data from a graph database is discussed in more detail below with respect to the method of FIG. 4.

A visualization capability is provided by the visualization tool based on the retrieved data at step 330. To provide the visualization, a hook to a graph database visualization tool may be created at step 130. A Keylines programming model may be used to hook the graph database visualization tool. JQuery or AJAX may be used to hook the JSON output from step 120 to Keylines. Javascript is recommended as the language to use for exterior Keylines web UI visualization.

Sample Java output-input to adapt Keylines software is provided below. String arrays is input from logic for display, and in some embodiments is decided upon by an administrator. A controller may decide which version to use: “graph stepping”, “graph complete”, or “graph node display”

sample JSON output
graph stepping:

{“columns”:[“picture.name”,“ID(x)”,“rel”,“ID(n)”,
“label.name”,“size”,“icon”,“icon_text”],“data
”:[[“Retail_Bank”,4,{“data”:{ },“type”:“Type”},
1,“Retail_Bank”,“1”,“none”,“none”],
[“Commerical_Bank”,5,{“data”:{ },“type”:“Type”},1,
“Commerical_Bank”,“1”,“none”,“none”]]}

graph complete:

```
{“columns”:[“picrure.name”,“rel”,“ID(n)”,“label.name”,“size”,“icon”,
“icon_text”],“data”:[[“Bank”,1,{“data”:{ },
“type”:“Type0”},0,“Bank”,“1”,“none”,“none”],
    [“Merchant”,2,{“data”:{ },“type”:“Type0”},0,“Merchant”,“1”,
    “none”,“none”],
    [“Person”,3,{“data”:{ },“type”:“Type0”},0,“Person”,“1”,
    “none”,“1”]]}
```

graph node display:

```
{“columns”:[“filler”],“data”:[[“name”,“Good_Bank”],
        [“Address”,“500_Tom_Road”],
        [“City”,“Hope”],
        [“Phone”,“821-830-5027”],
        [“Location”,“USA_Maine”],
        [“Coord”,“45.706179 -69.116829[USA_Maine]”]]}
```

sample input for graph stepping
Array is below:

ArrayElement1:[Node_picture=Retail_Bank;Node_relationship=
Type;Node_id=4;Node_{—parent=1;Node}_name=
Retail_Bank;Node_size=1;Node_icon=none;Node_itext=none]
ArrayElement2:[Node_picture=Comerical_Bank;Node_relationship=
Type;Node_id=5;Node_parent=1;Node_name=
Comerical_Bank;Node_size=1;Node_icon=none;Node_itext=none
]

The remainder graph complete and graph node display follows the same pattern.

FIG. 4 is a method for retrieving data from a graph database. The method of FIG. 4 provides more detail for step 320 of the method of FIG. 3. First, a connection may be established between a graph database and a visualization tool at step 410. A connection may be made by any protocol known to those skilled in the art. Next, a query may be generated to retrieve data from the graph database at step 420. The query may be generated as an AJAX call or other query suitable for retrieving data from the graph database. The query may be generated such that the particular data needed to generate the visualization is retrieved from the database. The particular data may be identified by previous queries to the database, input from a user having knowledge of the data in the database, or some other method.

The query may be transmitted to the graph database at step 430. The AJAX query may be transmitted over the internet or some other network to the remote graph database. A data stream may then be received from the graph database by the visualization tool at step 440. The data stream may include the particular data fields requested and specified as part of the query. A Java template may then be populated from the received data stream at step 440. In some embodiments, a JSON conversion may be performed to convert the received data stream to the Java template as needed. The Java template is in a format which allows a visualization tool to generate a graphical visualization from the received data stream.

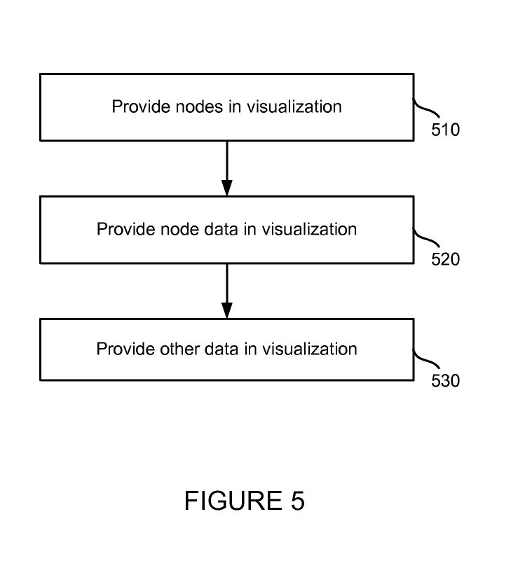

FIG. 5 is a method for providing a visualization interface. First, nodes are provided in a visualization interface at step 510. The nodes may be described by data received as part of the data stream and included in the Java template. Node data may then be provided to the visualization interface at step 520. The node data may specify text associated with a particular node, an icon associated with a particular node, a relationship associated with a particular node, or other data. After providing the node data, other data may be provided to the visualization interface at step 530.

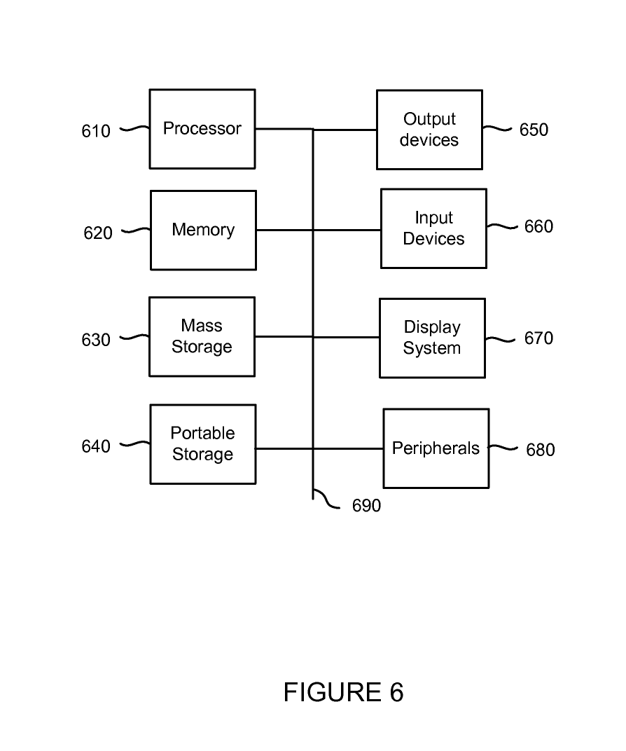

FIG. 6 illustrates an exemplary computing system 600 that may be used to implement a computing device for use with the present technology. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device.

Peripherals 680 may include any type of computer support device to add additional functionality to the computer system. For example, peripheral device(s) 680 may include a modem or a router.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for visualizing data, comprising:
retrieving data from a database in a first format;
adapting the retrieved data to a second format compatible with a visualization interface; and
providing a visualization based on the retrieved data having the second format.

2. The method of claim 1, wherein the database is graph database, the method further comprising:
retrieving a data stream from the graph database; and
populating a template from the data stream.

3. The method of claim 2, wherein the visualization is generated based on the template.

4. The method of claim 2, wherein the data stream is retrieved based on a query sent to the graph database.

5. The method of claim 1, herein the visualization includes one or more nodes.

6. The method of claim 5, wherein the visualization includes one or more relationships associated with each of the one or more nodes.

7. The method of claim 1, further comprising:
retrieving data from a second database in a third format;
adapting the retrieved data to the second format compatible with a visualization interface; and
providing the visualization based on the data retrieved from the first database having the second format and the second database having the second format.

8. The method of claim 1, wherein adapting the retrieved data includes performing a JSON conversion on the received data.

9. A computer readable storage medium having embodied thereon a program, the program being executable by a processor to visualize data, the method comprising:
retrieving data from a database in a first format;
adapting the retrieved data to a second format compatible with a visualization interface; and
providing a visualization based on the retrieved data having the second format.

10. The computer readable storage medium of claim 8, wherein the database is graph database, the method further comprising:
retrieving a data stream from the graph database; and
populating a template from the data stream.

11. The computer readable storage medium of claim 10, wherein the visualization is generated based on the template.

12. The computer readable storage medium of claim 10, wherein the data stream is retrieved based on a query sent to the graph database.

13. The computer readable storage medium of claim 8, wherein the visualization includes one or more nodes.

14. The computer readable storage medium of claim 13, wherein the visualization includes one or more relationships associated with each of the one or more nodes.

15. The computer readable storage medium of claim 8, further comprising:
retrieving data from a second database in a third format;
adapting the retrieved data to the second format compatible with a visualization interface; and
providing the visualization based on the data retrieved from the first database having the second format and the second database having the second format.

16. The computer readable storage medium of claim 8, wherein adapting the retrieved data includes performing a JSON conversion on the received data.

17. A system for visualizing data, comprising:
a processor;
a memory;
one or more modules stored in memory and executable by the processor to retrieve data from a database in a first format, adapt the retrieved data to a second format compatible with a visualization interface, and provide a visualization based on the retrieved data having the second format.

18. The system of claim 17, wherein the database is graph database, the one or more modules further executable to retrieve a data stream from the graph database and populate a template from the data stream.

19. The system of claim 18, wherein the visualization is generated based on the template.

20. The system of claim 18, wherein the data stream is retrieved based on a query sent to the graph database.

21. The system of claim 17, herein the visualization includes one or more nodes.

22. The system of claim 21, wherein the visualization includes one or more relationships associated with each of the one or more nodes.

23. The system of claim 17, the one or more modules further executable to retrieve data from a second database in a third format, adapt the retrieved data to the second format compatible with a visualization interface, and provide the visualization based on the data retrieved from the first database having the second format and the second database having the second format.

24. The system of claim 17, wherein adapting the retrieved data includes performing a JSON conversion on the received data.
